(19) United States
(12) Patent Application Publication
(10) Pub. No.: US 2017/0005563 A1
(43) Pub. Date: Jan. 5, 2017

(54) Zero-Voltage Transition in Power Converters with an Auxiliary Circuit

(71) Applicant: ARIZONA BOARD OF REGENTS ON BEHALF OF ARIZONA STATE UNIVERSITY, Scottsdale, AZ (US)

(72) Inventor: Rajapandian AYYANAR, Gilbert, AZ (US)

(73) Assignee: ARIZONA BOARD OF REGENTS ON BEHALF OF ARIZONA STATE UNIVERSITY, Scottsdale, AZ (US)

(21) Appl. No.: 15/105,262

(22) PCT Filed: Jan. 6, 2015
(86) PCT No.: PCT/US2015/010316

§ 371 Date: Jun. 16, 2016

Related U.S. Application Data
(60) Provisional application No. 61/924,544, filed on Jan. 7, 2014.

(51) Int. Cl. H02M 1/088

(52) U.S. Cl. CPC H02M 1/088; H02M 2001/0058

(57) ABSTRACT

An auxiliary circuit may be used to assist in the operation of a power converter to obtain zero-voltage switching. For example, an auxiliary circuit including a low-voltage switch, a diode, and an inductor may be coupled to a power converter, such as a DC-to-DC buck converter or a DC-to-AC inverter or rectifier. The auxiliary circuit may consume current during transitions in the power converter to obtain zero-voltage switching.

### CROSS-REFERENCE TO RELATED APPLICATIONS

This application claims the benefit of U.S. Provisional Patent Application No. 61/924,544 entitled “ZERO-VOLTAGE TRANSITION IN DC-TO-DC CONVERTERS WITH AUXILIARY CIRCUIT,” filed Jan. 7, 2014, which is expressly incorporated by reference herein in its entirety.

### FIELD OF THE DISCLOSURE

This disclosure relates to methods and apparatuses for power conversion, and more particularly relates to zero-voltage switching in power conversion circuits.

### BACKGROUND

The trend in power electronic converters, such as DC-to-DC, DC-to-AC, or AC-to-DC converters, is to move towards higher switching frequencies. Several benefits of higher switching frequencies include a reduction in filter size resulting in higher power density, improved transient performance, and/or moving the electromagnetic interference (EMI) above a particular frequency band. However, high switching frequencies may also result in proportionally higher switching loses. Some conventional solutions have included soft-switching topologies. However, these soft-switching topologies have higher conduction losses, variable frequency operation, more complex control, and/or addition of several components, including multiple switches that results in substantial losses.

### BRIEF SUMMARY

Embodiments described below may achieve zero-voltage transitions using an auxiliary circuit coupled to a DC-to-DC, DC-to-AC, or AC-to-DC power converter. The auxiliary circuit may include a low-voltage switch, a diode, and an inductor or a coupled inductor. The auxiliary circuit may conduct during transition periods of the main power converter, which together with the low-voltage switch may reduce conduction losses in the power converter. The low-voltage switch may also have low switching losses. In some embodiments, the switching timing of the switch of the auxiliary circuit may be adaptively controlled based on the operating conditions within the power converter, such as input and output voltages, load current, and switch voltages and currents. Although embodiments of a DC-to-DC power converter are primarily described, other power converters, such as DC-to-AC and AC-to-DC power converters, may include the auxiliary circuit described below to reduce power losses associated with switches in the power converters. In addition to reducing switching losses, the auxiliary circuit may improve load transient performance in the power converter.

According to one embodiment, an apparatus may include a first switch and a second switch, wherein a first terminal of the first switch and a first terminal of the second switch are coupled to a first node. The apparatus may also include a first inductor, wherein a first terminal of the first inductor is coupled to the first node. The apparatus may further include an auxiliary circuit comprising: a third switch; a second inductor; and a first diode, wherein a first terminal of the auxiliary circuit is coupled to the first node and a second terminal of the auxiliary circuit is coupled to a second terminal of the first inductor.

According to another embodiment, a method may include switching off a first switch. The method may also include switching on a second switch after the first switch has been switched off, wherein current flowing through the second switch while the second switch is on is provided by at least a first inductor. The method may further include switching on an auxiliary circuit while the second switch is on, wherein switching on the auxiliary circuit causes a reduction in the current flowing through the second switch and reversal of current direction. The method may also include switching off the second switch, wherein switching off the second switch causes a first capacitance associated with the first switch to discharge and causes a second capacitance associated with the second switch to charge. The method may further include switching on the first switch after the second switch has been switched off and the first capacitance associated with the first switch is fully discharged.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The following drawings form part of the present specification and are included to further demonstrate certain aspects of the present disclosure. The disclosure may be better understood by reference to one or more of these drawings in combination with the detailed description of specific embodiments.

FIG. 1 is a circuit illustrating a power converter with an auxiliary circuit according to a first embodiment of the disclosure.

FIG. 2 is a flow chart illustrating a method for controlling switches in a power converter that includes an auxiliary circuit described in the disclosure to achieve zero-voltage transitions according to one embodiment of the disclosure.

FIG. 3 is a circuit illustrating a power converter with an auxiliary circuit according to a second embodiment of the disclosure.

FIG. 4 is a circuit illustrating a power converter with an auxiliary circuit according to a third embodiment of the disclosure.

FIG. 5 is a circuit illustrating a power converter with an auxiliary circuit according to a fourth embodiment of the disclosure.

FIG. 6 is a circuit illustrating a power converter with an auxiliary circuit according to a fifth embodiment of the disclosure.

FIG. 7 is a circuit illustrating a power converter with an auxiliary circuit according to a sixth embodiment of the disclosure.

FIG. 8 is a circuit illustrating a power converter with an auxiliary circuit according to a seventh embodiment of the disclosure.

FIG. 9 is a circuit illustrating a power converter with an auxiliary circuit according to an eighth embodiment of the disclosure.

FIG. 10 is a circuit illustrating a power converter with an auxiliary circuit according to a ninth embodiment of the disclosure.

FIG. 11 is a circuit illustrating a power converter with an auxiliary circuit according to a tenth embodiment of the disclosure.

FIG. 12 is a circuit illustrating a power converter with an auxiliary circuit according to a eleventh embodiment of the disclosure.

FIG. 13 is a circuit illustrating a power converter with an auxiliary circuit according to a twelfth embodiment of the disclosure.

FIG. 14 is a schematic diagram illustrating how an auxiliary circuit embodiment of this disclosure can be used in a number of power converters in DC-DC, DC-AC and AC-DC applications to achieve zero voltage transitions according to an embodiment of the disclosure.

### DETAILED DESCRIPTION

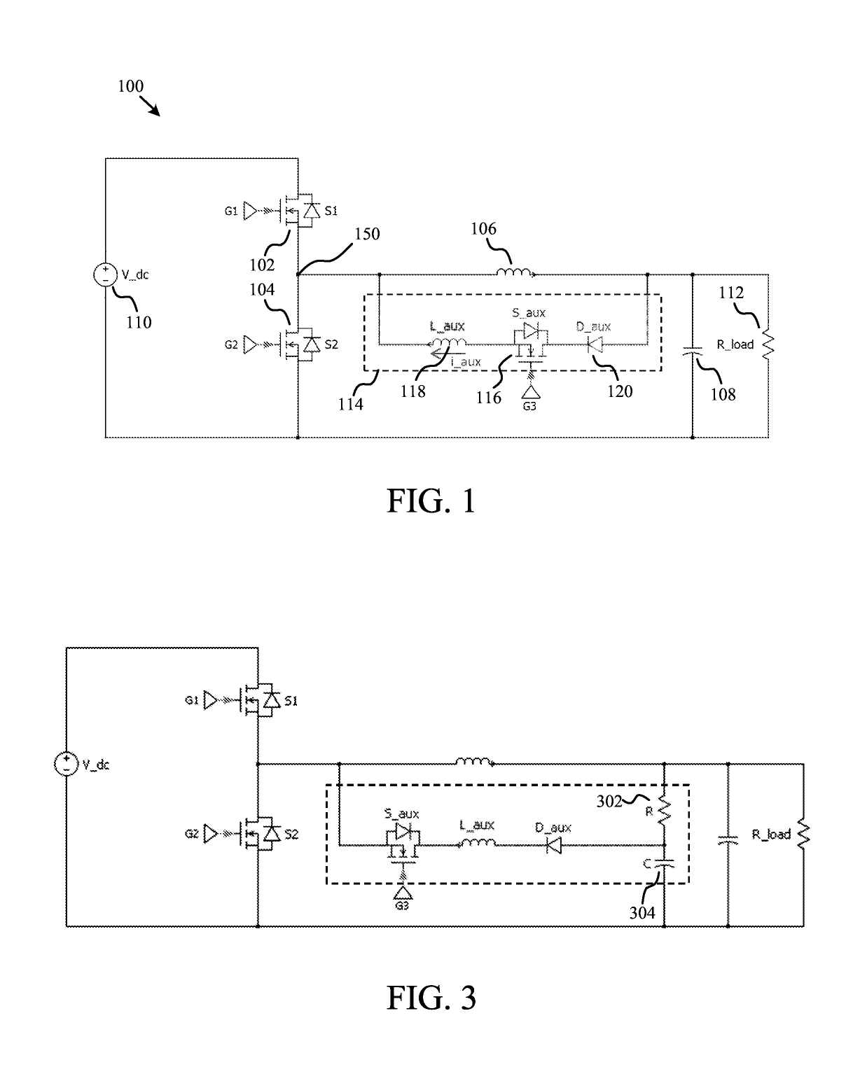

FIG. 1 is a circuit illustrating a DC-to-DC power converter with an auxiliary circuit according to a first embodiment of the disclosure. According to the embodiment of FIG. 1, the power converter circuit 100 of FIG. 1 includes a first switch 102, a second switch 104, a first inductor 106, and a capacitor 108. In the embodiment of FIG. 1, one terminal of each of the first switch 102, second switch 104, and the first inductor 106 may be coupled to a first node 150.

In some embodiments, the first switch 102, second switch 104, first inductor 106, and capacitor 108 may collectively be referred to as a synchronous buck power converter, which may be configured to convert a DC voltage input from a power source 110 to a lower DC voltage output for an output load 112. For example, as illustrated in FIG. 1, a second terminal of the first switch 102 may be coupled to a first terminal of the power source 110 and a second terminal of the second switch 104 may be coupled to a second terminal of the power source 110. In addition, as illustrated in the embodiment of FIG. 1, the second terminal of the first inductor 106 may be coupled to the resistive output load 112. In some embodiments, the resistive load 112 may be coupled in parallel with a capacitor 108.

According to the embodiment of FIG. 1, the power converter circuit 100 also includes the auxiliary circuit 114. The auxiliary circuit 114 of FIG. 1 includes a third switch 116, a second inductor 118, and a diode 120. As illustrated in FIG. 1, a first terminal of the auxiliary circuit may be coupled to the first node 150 and a second terminal of the auxiliary circuit 114 may be coupled to the second terminal of the first inductor 106. In some embodiments, the third switch 116, second inductor 118, and first diode 120 may be coupled in series to each other. In some embodiments, in order to facilitate zero-voltage transitions in the power converter 100 using the auxiliary circuit 114, the first switch 102 and the second switch 104 may be configured to be on during non-overlapping time periods, and the third switch 116 may be configured to be switched on while the second switch 104 is on and switched off while the first switch 102 is on.

According to one embodiment, such as the embodiment illustrated in FIG. 1, the switches 102, 104, and 116 may be implemented with transistors to provide configurable control of the switches 102, 104, and 116. In another embodiment, one or more of each of the switches 102, 104, and 116 may be a diode. For example, in one embodiment, switch 104 may be implemented with a diode. In yet another embodiment, a switch, such as any one of the switches 102, 104, and 116, may include a combination of one or more transistors and one or more diodes. In some embodiments, a diode may be an intrinsic diode of a transistor switch.

In some embodiments, the voltage rating for the third switch 116 may be approximately equal to the desired output voltage across the output load 112, which may result in a low on resistance (R_{DS}), low conduction loss, and low gate drive loss and cost for the third switch 116. In other embodiments, the voltage rating for the third switch 116 may be approximately equal to the input voltage provided by the power source 110, or approximately equal to the difference between the input voltage provided by the power source 110 and the output voltage across the output load 112.

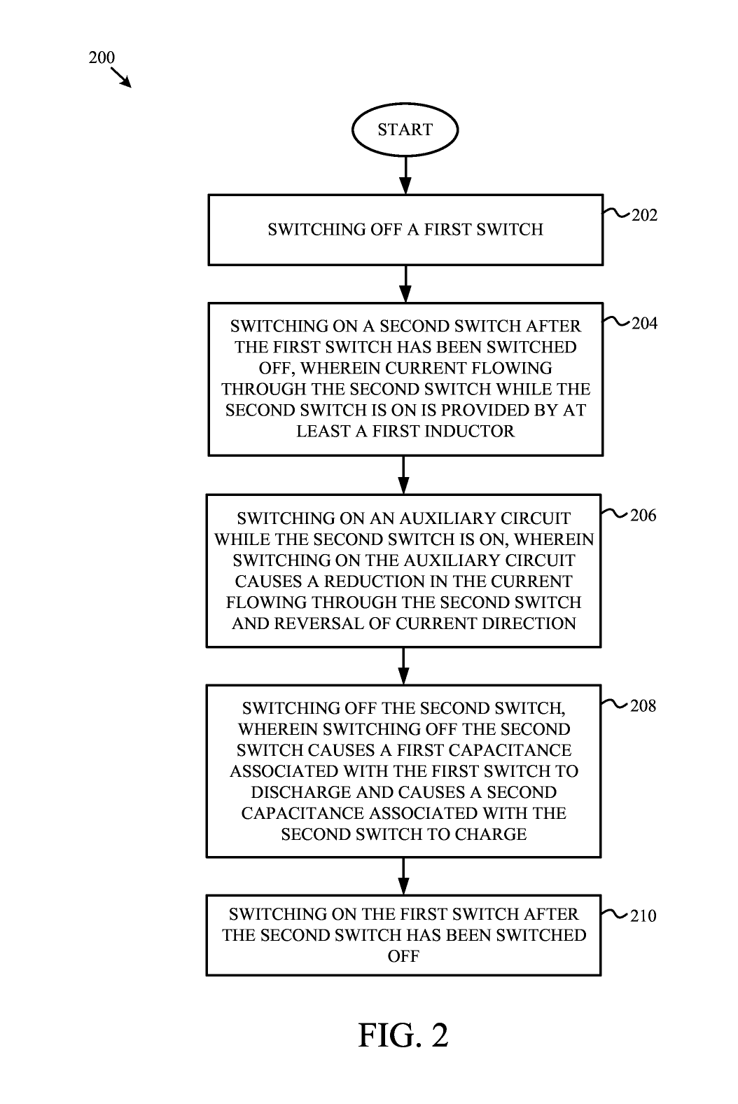

FIG. 2 is a flow chart illustrating a method for controlling switches in a power converter that includes an auxiliary circuit described in the disclosure to achieve zero-voltage transitions according to one embodiment of the disclosure. Embodiments of method 200 may be implemented with the embodiments of this disclosure described with respect to FIGS. 1 and 3-11. Specifically, method 200 includes, at block 202, switching off a first switch. At block 204, method 200 may include switching on a second switch after the first switch has been switched off, wherein current flowing through the second switch while the second switch is on may be provided by at least a first inductor. According to one embodiment, the voltage across the second switch may be approximately zero immediately prior to switching on the second switch, which as a result may make the corresponding second switch transition a zero-voltage transition. In some embodiments, the first switch, second switch, and first inductor may correspond to the first switch 102, second switch 104, and first inductor 106 illustrated in FIG. 1.

At block 206, method 200 includes switching on an auxiliary circuit while the second switch is on, wherein switching on the auxiliary circuit may cause a reduction in the current flowing through the second switch and reversal of current direction. For example, in some embodiments, the current flowing through the second switch may reduce to zero and then reverse direction. In some embodiments, the turn-on instant of the auxiliary circuit switch may be controlled adaptively based on the operating conditions within the power converter, such as input and output voltages and load current. According to an embodiment, switching on the auxiliary circuit may also cause an increase in the current flowing through the auxiliary circuit. In some embodiments, the rate at which the current flowing through the second switch decreases and the rate at which the current flowing through the auxiliary switch increases may be approximately equal. In some embodiments, the auxiliary circuit may correspond to auxiliary circuit 114 illustrated in FIG. 1, which may include a third switch, a second inductor, and a first diode. In some embodiments, the current flowing through the second switch may continue to reduce until the current reaches zero and then reverses direction.

Method 200 may further include, at block 208, switching off the second switch, wherein switching off the second switch causes a first capacitance associated with the first switch to discharge and causes a second capacitance associated with the second switch to charge. In some embodiments, each of the first capacitance associated with the first switch and the second capacitance associated with the second switch may include intrinsic capacitance of the switch, extrinsic capacitance coupled to the switch, or a combination of intrinsic and extrinsic capacitance.

At block 210, method 200 includes switching on the first switch after the second switch has been switched off. For example, in some embodiments, the first capacitance associated with the first switch may discharge and the second capacitance associated with the second switch may charge until a voltage across the first switch is approximately zero. After the voltage across the first switch is approximately zero, the first switch may be switched on, which as a result may make the corresponding first switch transition a zero-voltage transition.

In some embodiments, the auxiliary circuit may be switched off after the first switch has been switched on and the current through the auxiliary circuit is approximately zero. According to an embodiment, the switching off of the auxiliary circuit may be a zero-current transition. For example, after the first switch has been switched on, the current flowing through the auxiliary circuit may decrease until the current flowing through the auxiliary circuit becomes approximately zero. The diode within the auxiliary circuit, such as first diode 120 illustrated in FIG. 1, may prevent current in the opposite direction from flowing, so the current flowing through the auxiliary circuit may remain at approximately zero. Therefore, minimal or no current may be flowing through the auxiliary circuit when the switch within the auxiliary circuit, such as third switch 116 illustrated in FIG. 1, is turned off, which as a result may make the corresponding auxiliary switch transition a zero-current transition. Similarly, in some embodiments, minimal or no current may be flowing through the auxiliary circuit when the switch within the auxiliary circuit is turned on, which as a result may make the corresponding auxiliary switch transition a zero-current transition.

In some embodiments, the amount of time Tₐᵤₓ between the time when the third switch 116 of the auxiliary circuit 114 is turned on and the time when the second switch 104 is turned off may be determined based on the time needed for the current flowing through the auxiliary circuit to reach an adjustable predetermined value. In another embodiment, the time Tₐᵤₓ may be determined based on the time needed for the voltage across the second switch 104 to be approximately equal to the desired output voltage across the output load 112. In yet another embodiment, the time Tₐᵤₓ can be calculated based on the desired output voltage across the output load, the inductance value of the inductor within the auxiliary circuit, the drops in series resistances of components of the power converter, the input voltage provided by the power source, and the resonant period of the equivalent LC circuit.

One advantage of embodiments of the disclosure may be that because the current flowing through the auxiliary circuit may be present for only a small time interval during which the first switch is also on, the auxiliary circuit may introduce minimal losses. Therefore, embodiments of the disclosure may provide zero-voltage transitions in power converters while introducing minimal losses to achieve the zero-voltage transitions. In addition, whereas prior art solutions require a split capacitor to generate two required voltage levels to achieve zero-voltage transitions, certain embodiments of the disclosure may achieve zero-voltage transitions without requiring a split capacitor to generate two required voltage levels. Moreover, certain embodiments of the disclosure may create pulsed currents at the output, whereas no prior art solution creates a pulsed current at the output.

Another advantage of embodiments of the disclosure may be that the magnitude of the current flowing through the auxiliary circuit 114 may be made adaptive so as to follow the load current value. For example, by controlling when the auxiliary switch 116 is switched on, the magnitude of the current flowing through the auxiliary circuit can be controlled to be larger than the load current by a magnitude necessary to discharge the capacitance associated with the first switch 102 and to charge the capacitance associated with the second switch 104. In addition, by maintaining the magnitude of the current flowing through the auxiliary circuit low when the output load 112 is not large, the efficiency over the entire load range may be improved.

Yet another advantage of embodiments of the disclosure may be that the auxiliary circuit embodiments of the disclosure may also be used to improve the transient performance of power converters because the auxiliary circuit may cause the output current to become zero or negative faster than when the auxiliary circuit is not used.

In some embodiments, the magnitude by which the current flowing in the auxiliary circuit is larger than the load current can also be configured to adaptively follow the input voltage, for example, to reduce the current peak and losses.

According to another embodiment, when the output load is extremely low and the instantaneous current in the main inductor is negative at the instant that the second switch 104 is switched off, the auxiliary circuit may be disabled by not switching on the auxiliary switch 116.

The schematic flow chart diagram of FIG. 2 is generally set forth as a logical flow chart diagram. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method.

Additionally, the order in which a particular method occurs may or may not strictly adhere to the order of the corresponding steps shown. For example, while, for purposes of simplicity of explanation, method 200 is shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g. device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

FIG. 3 is a circuit illustrating a power converter with an auxiliary circuit according to a second embodiment of the disclosure. For example, in some embodiments, the embodiment illustrated in FIG. 3 may be used when large current pulsations at the output resulting from current flowing through the auxiliary circuit are not desirable or not acceptable. The circuit embodiment illustrated in FIG. 3 includes all the components in the circuit embodiment illustrated in FIG. 1, but the auxiliary circuit embodiment illustrated in FIG. 3 also includes an additional resistor 302 and capacitor 304 to prevent current pulses from the output load or input source. In some embodiments, loss in the additional resistor may be negligible for the typical duration and magnitude of the current flowing through the auxiliary circuit. In addition, in certain embodiments of the disclosure, the voltage rating of the switch within the auxiliary circuit may be approximately equal to the desired output voltage across the output load.

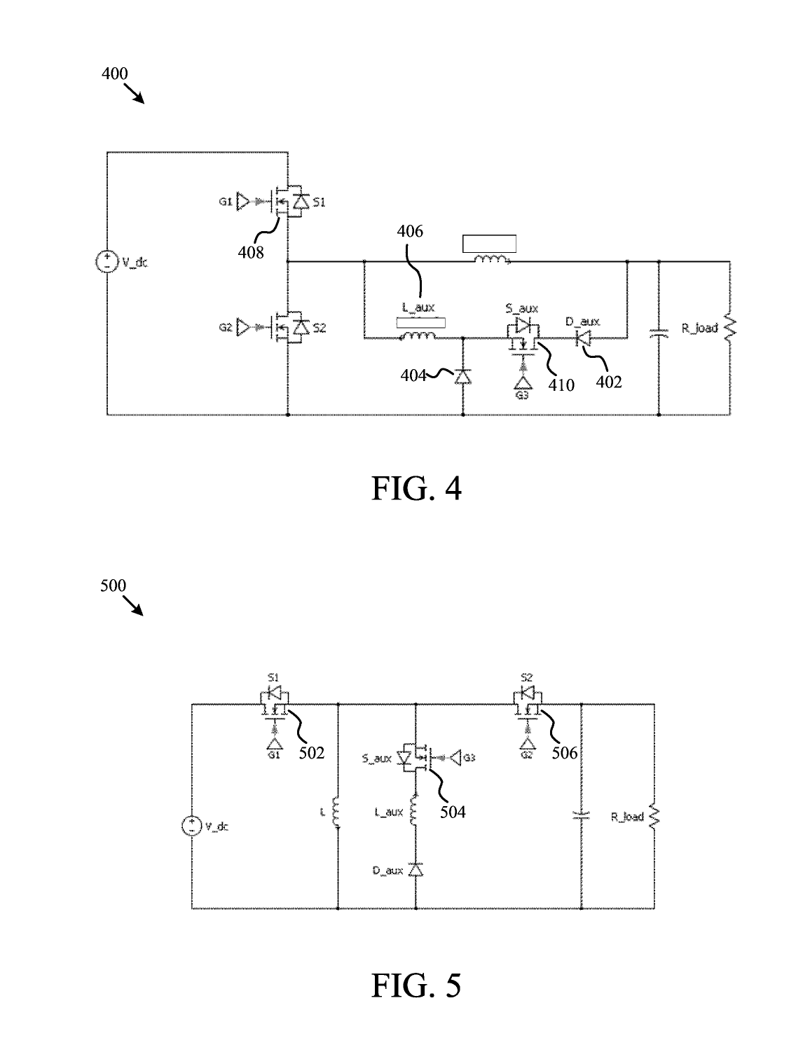

FIG. 4 is a circuit illustrating a power converter with an auxiliary circuit according to a third embodiment of the disclosure. For example, in some embodiments, the power converter 400 illustrated in FIG. 4 may be used when the trigger voltage for the first diode 402 within the auxiliary circuit is large, such as, for example, 0.95 V or above, and the switching frequency of the power converter circuit 400 is high. In some embodiments, the frequency at which the switching frequency is considered high may vary depending on the application and the specifications for a particular application. The power converter 400 illustrated in FIG. 4 includes all the components in the power converter 100 illustrated in FIG. 1, but the auxiliary circuit embodiment illustrated in FIG. 4 also includes an additional diode 404. When the trigger voltage for the first diode 402 is large and/or the switching frequency of the power converter 400 is high, the current flowing through the second inductor 406 may not be able to reach zero before the first switch 408 is switched off. By using the additional diode 404, the auxiliary switch 410 within the auxiliary circuit may be switched off by turning off its gate drive G3, and the additional diode 404 may provide an additional path to ground to further reduce the current flowing through the second inductor 406 until the current flowing through the second inductor 406 is approximately zero.

FIG. 5 is a circuit illustrating a power converter with an auxiliary circuit according to a fourth embodiment of the disclosure. In particular, FIG. 5 illustrates a DC-to-DC buck-boost power converter 500 using an auxiliary circuit embodiment of the disclosure to achieve zero-voltage switch transitions.

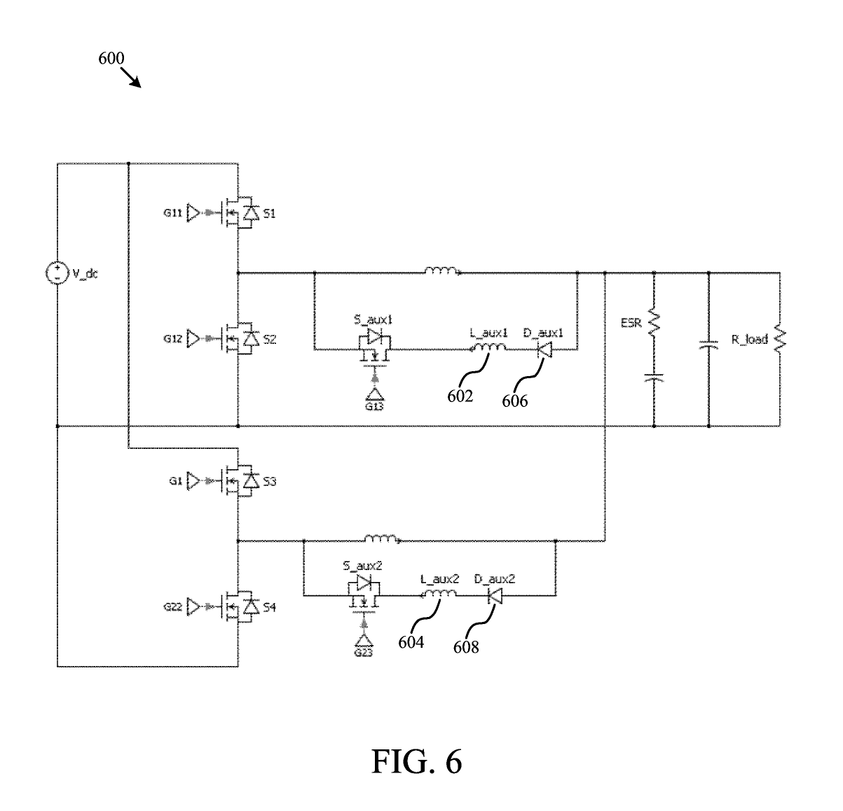

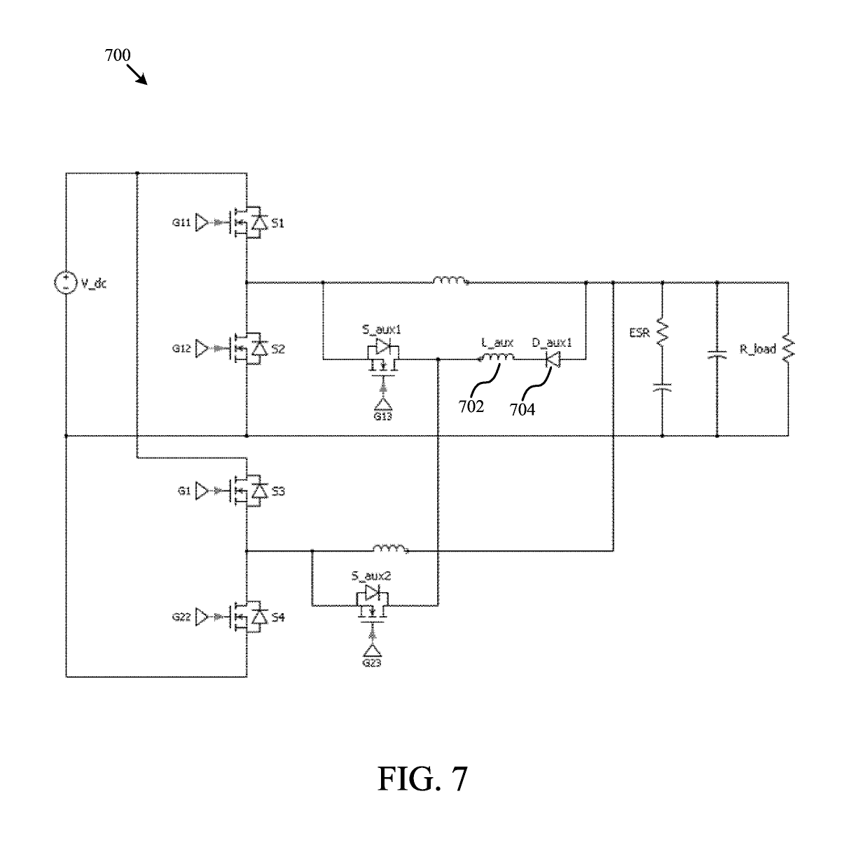

FIG. 6 is a circuit illustrating a power converter with an auxiliary circuit according to a fifth embodiment of the disclosure. In particular, FIG. 6 illustrates a multi-phase power converter 600 using an auxiliary circuit embodiment of the disclosure to achieve zero-voltage switch transitions. FIG. 7 is a circuit illustrating a power converter with an auxiliary circuit according to a sixth embodiment of the disclosure. In particular, FIG. 7 illustrates a multi-phase power converter 700 using an auxiliary circuit embodiment of the disclosure to achieve zero-voltage switch transitions similar to the multi-phase power converter 600 illustrated in FIG. 6. The distinction between power converter 600 and power converter 700 is that power converter 600 uses two auxiliary inductors 602 and 604 and two auxiliary diodes 606 and 608, whereas power converter 700 uses a single auxiliary inductor 702 and single auxiliary diode 704.

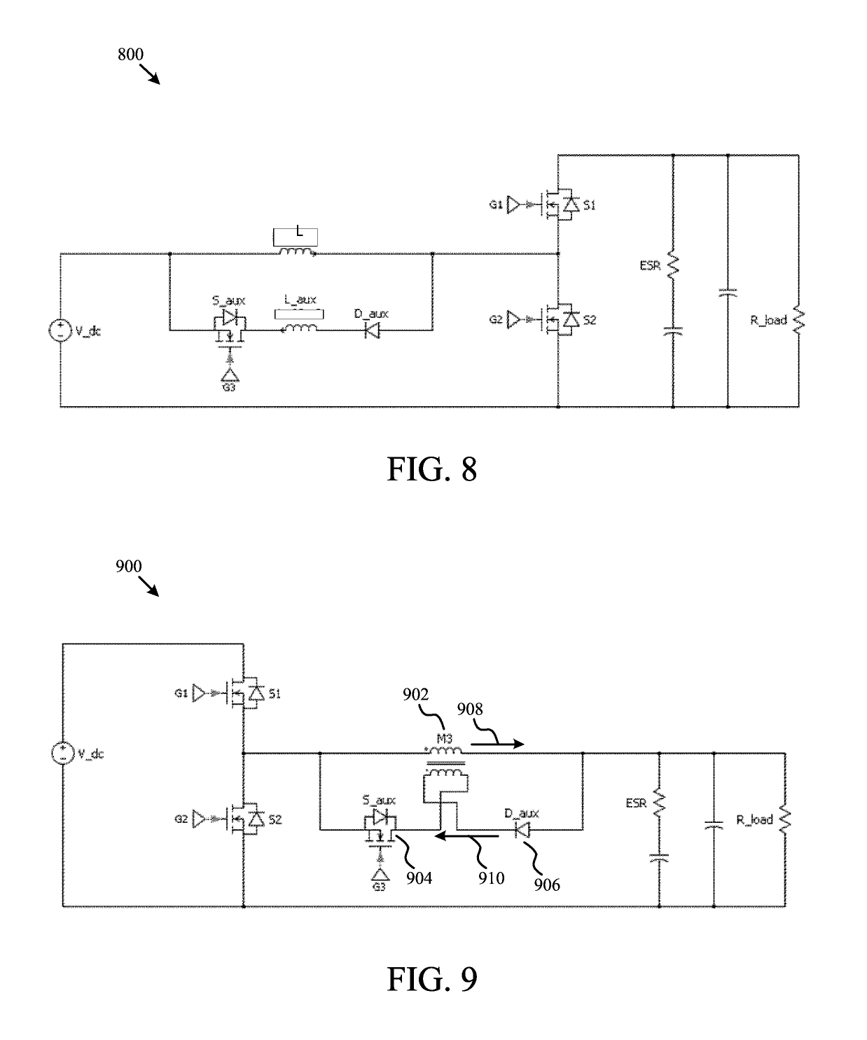

FIG. 8 is a circuit illustrating a power converter with an auxiliary circuit according to a seventh embodiment of the disclosure. In particular, FIG. 8 illustrates a DC-to-DC boost power converter 800 using an auxiliary circuit embodiment of the disclosure to achieve zero-voltage switch transitions.

FIG. 9 is a circuit illustrating a power converter with an auxiliary circuit according to an eighth embodiment of the disclosure. In particular, FIG. 9 illustrates a power converter 900 using an auxiliary circuit embodiment of the disclosure to achieve zero-voltage switch transitions. The power converter 900 illustrated in FIG. 9 is similar to power converter 100 illustrated in FIG. 1. The distinction between power converter 100 and power converter 900 is that power converter 100 uses two inductors 106 and 118, whereas power converter 900 uses a single inductor 902 that is coupled between the primary signal path 908 and the auxiliary signal path 910. In other words, power converter 900 is similar to power converter 100 with the exception that the first inductor 106 and the second inductor 118 in power converter 100 are magnetically coupled in FIG. 9 to create power converter 900. In some embodiments, power converter 900 may be used to improve the trade-off between (1) the ratings for the auxiliary switch 904 and the auxiliary diode 906 and (2) the magnitude of the current flowing through the auxiliary switch 904 and the auxiliary diode 906. Improving the trade-off may result in lower conduction losses in some embodiments, such as, for example, in applications where the output voltage is lower than in most other applications. For example, according to an embodiment, the current in the auxiliary signal path 910 of power converter 900 may be reduced by half for a 1:1 turns ratio in coupled inductor 902. In addition, in some embodiments, the voltage rating for the auxiliary switch 904 may be increased by employing the coupled inductor 902. In certain embodiments, higher turns ratios for coupled inductor 902 may result in a lower-magnitude current flowing in auxiliary signal path 910 and a higher voltage rating for auxiliary switch 904. One of skill in the art will readily recognize that although some prior-art solutions may require coupled inductors to achieve zero-voltage transitions, in embodiments of this disclosure a coupled inductor may not be necessary to achieve zero voltage transitions but may still be used to improve performance. In addition, even though FIG. 9 illustrates the use of an auxiliary circuit with a coupled inductor when the main power converter is a buck converter, one of skill in the art will readily recognize that an auxiliary circuit with a coupled inductor may also be used when the main power converter is not a buck converter.

According to an embodiment, the inductance in the auxiliary circuit of power converter 900 may correspond to the leakage inductance of the coupled inductor 902. Therefore, in some embodiments, as the current flowing through one winding of coupled inductor 902 increases the current flowing through the other winding of coupled inductor 904 may decrease proportionately.

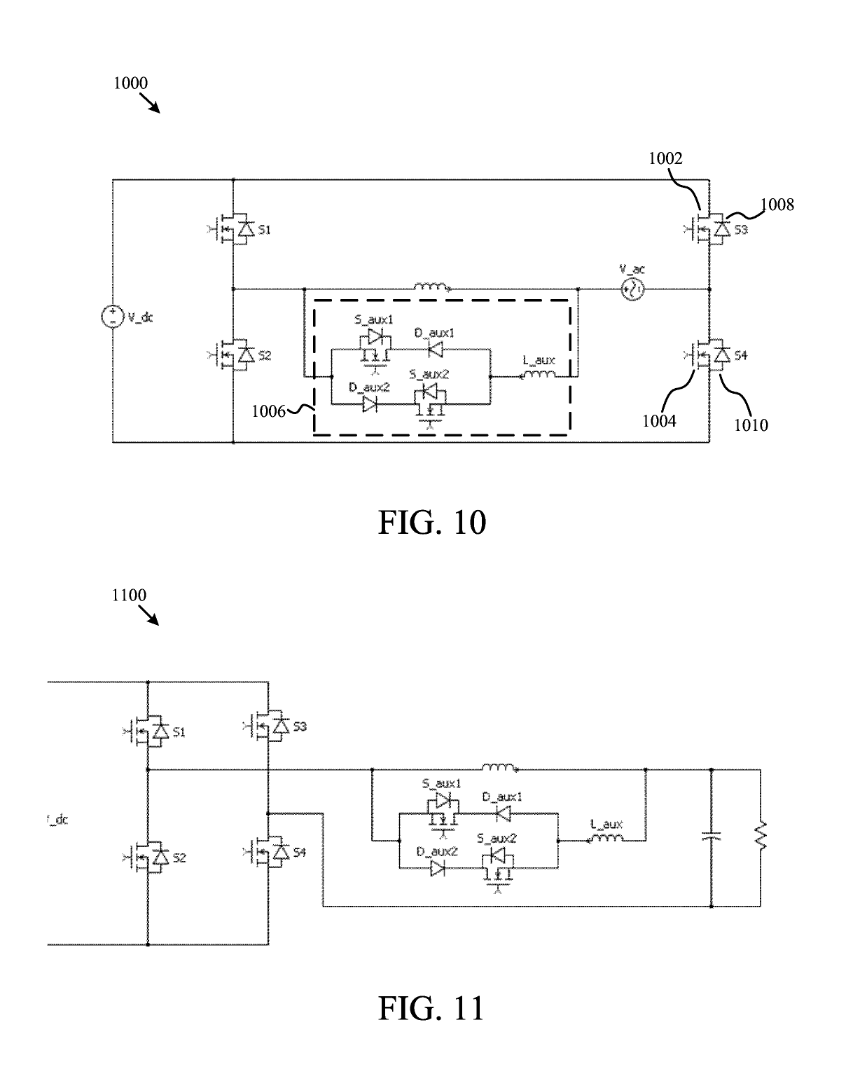

FIG. 10 is a circuit illustrating a power converter with an auxiliary circuit according to a ninth embodiment of the disclosure. In particular, FIG. 10 illustrates a DC-to-AC (or AC-to-DC) grid-connected power converter 1000 using an auxiliary circuit embodiment of the disclosure to achieve zero-voltage switch transitions. In some embodiments, such as for AC-to-DC, DC-to-AC, and other bidirectional power flow applications, the switch in the auxiliary circuit 1006 may be realized using a controlled bidirectional switch. In the embodiment illustrated in FIG. 10, in the auxiliary circuit 1006, the bidirectional switch may be implemented using two transistors S_aux1 and S_aux2 and two diodes D_aux1 and D_aux2. The auxiliary circuit 1006 may conduct each time there needs to be a commutation from a diode to a transistor in the same leg, such as, for example, from diode 1008 to transistor 1004 or from diode 1010 to transistor 1002.

FIG. 11 is a circuit illustrating a power converter with an auxiliary circuit according to a tenth embodiment of the disclosure. In particular, FIG. 11 illustrates a DC-to-AC stand-alone power inverter 1100 using an auxiliary circuit embodiment of the disclosure to achieve zero-voltage switch transitions.

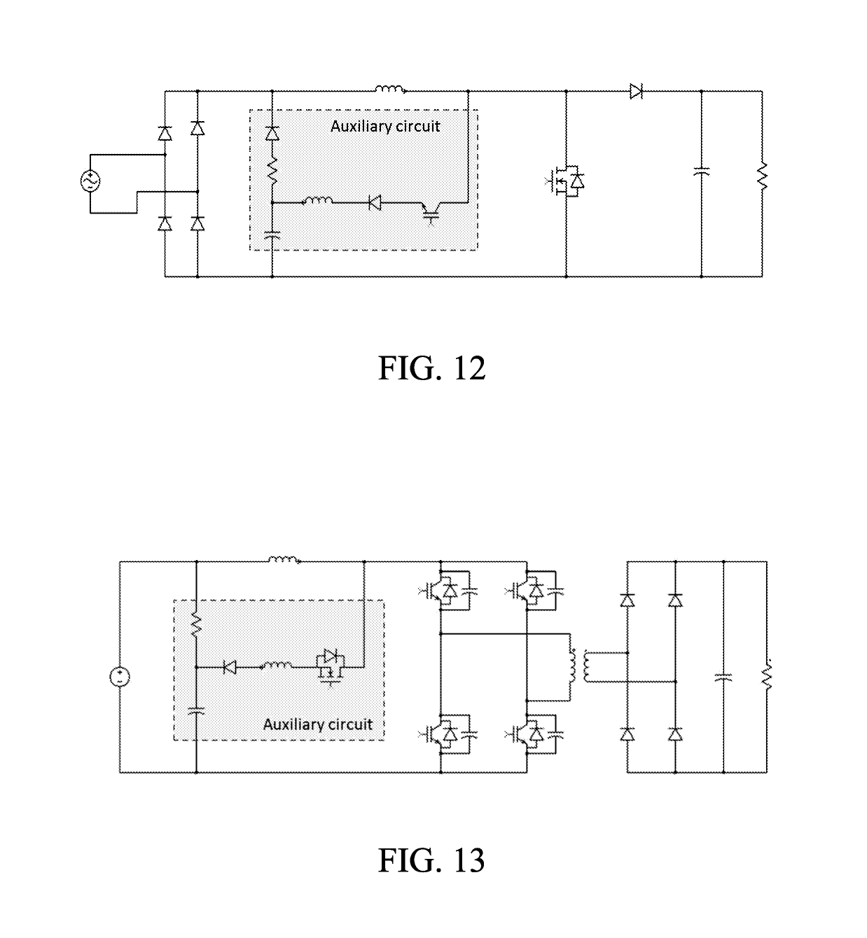

FIG. 12 is a circuit illustrating a power converter with an auxiliary circuit according to a eleventh embodiment of the disclosure. In particular, FIG. 12 illustrates an AC-to-DC rectifier with a power factor correction (PFC) feature using an auxiliary circuit embodiment of the disclosure to achieve zero-voltage switch transitions.

FIG. 13 is a circuit illustrating a power converter with an auxiliary circuit according to a twelfth embodiment of the disclosure. In particular, FIG. 13 illustrates a transformer-isolated boost DC-DC converter using an auxiliary circuit embodiment of the disclosure to achieve zero-voltage switch transitions.

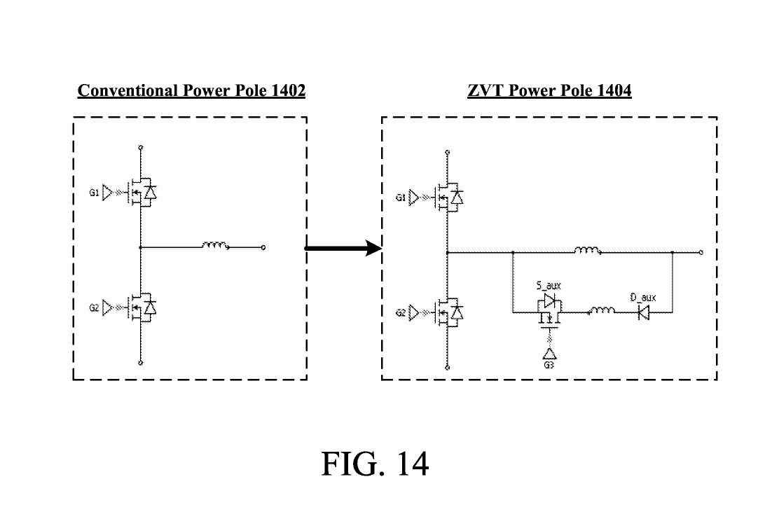

FIG. 14 illustrates how an auxiliary circuit embodiment of this disclosure can be used in a number of power converters in DC-DC, DC-AC and AC-DC applications to achieve zero voltage transitions. In particular, FIG. 14 illustrates that an auxiliary circuit embodiment of this disclosure can be used in a number of power converters in DC-DC, DC-AC and AC-DC applications to achieve zero voltage transitions by replacing a conventional power pole 1402 that includes two switches and an inductor with the generic zero-voltage transition (ZVT) power pole 1404 which has the additional auxiliary circuit. As an example, and not limitation, a DC-to-DC converter which may use an auxiliary circuit embodiment of this disclosure to achieve zero-voltage transitions may include any one of a synchronous buck converter, boost converter, buck-boost converter, Cuk converter, single-ended primary inductor converter (SEPIC), and multiphase converter. In some embodiments, the DC-to-DC converter may also be a DC-to-DC bidirectional power flow converter.

In some embodiments, the replacement of the conventional power pole 1402 with the ZVT power pole 1404 may take into account the current direction in unidirectional DC-DC power converters. In addition, in some embodiments, a bi-directional (two MOSFETs and two diodes) switch may be used within the auxiliary circuit for bi-directional and DC-AC or AC-DC applications to support bidirectional currents and bipolar voltages.

Similar to the switches in power converter 100, in certain embodiments, the switches in the power converter embodiments illustrated in FIGS. 3-11 may be implemented with transistors to provide configurable control of the switches. In other embodiments, one or more of each of the switches in the power converter embodiments illustrated in FIGS. 3-11 may be diodes. In yet other embodiments, a switch, such as any one of the switches in the power converter embodiments illustrated in FIGS. 3-11 may include a combination of one or more transistors and one or more diodes.

If implemented in firmware and/or software, the methods described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the methods outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. An apparatus for reducing power losses associated with switch transitions, comprising:
a first switch and a second switch, wherein a first terminal of the first switch and a first terminal of the second switch are coupled to a first node;
a first inductor, wherein a first terminal of the first inductor is coupled to the first node; and
an auxiliary circuit, comprising:
a third switch;
a second inductor; and
a first diode,
wherein a first terminal of the auxiliary circuit is coupled to the first node and a second terminal of the auxiliary circuit is coupled to a second terminal of the first inductor.

2. The apparatus of claim 1, wherein the first and second switches are configured to be on during non-overlapping time periods, and the third switch is configured to be switched on while the second switch is on and switched off while the first switch is on.

3. The apparatus of claim 1, wherein the third switch, second inductor, and first diode are coupled in series to each other.

4. The apparatus of claim 1, wherein each of the first switch, second switch, and third switch comprises at least one of a transistor and a diode.

5. The apparatus of claim 1, wherein a second terminal of the first switch is coupled to a first terminal of a power source and a second terminal of the second switch is coupled to a second terminal of the power source.

6. The apparatus of claim 5, wherein the second terminal of the first inductor is further coupled to resistive load and to a capacitor in parallel with the resistive load.

7. The apparatus of claim 1, wherein the apparatus is a DC-to-DC power converter.

8. The apparatus of claim 7, wherein the DC-to-DC power converter is one of a synchronous buck converter, boost converter, buck-boost converter, Cuk converter, single-ended primary inductor converter (SEPIC), and multiphase converter.

9. The apparatus of claim 1, wherein the apparatus is one of a DC-to-AC power converter and an AC-to-DC power converter.

10. The apparatus of claim 1, wherein the auxiliary circuit further comprises a resistor and a capacitor to prevent current pulses from an output load or input power source.

11. The apparatus of claim 1, wherein the second inductor of the auxiliary circuit is magnetically coupled to the first inductor.

12. The apparatus of claim 1, wherein the auxiliary circuit further comprises a second diode.

13. A method for reducing power losses associated with switch transitions, comprising:
switching off a first switch;
switching on a second switch after the first switch has been switched off, wherein current flowing through the second switch while the second switch is on is provided by at least a first inductor;
switching on an auxiliary circuit while the second switch is on, wherein switching on the auxiliary circuit causes a reduction in the current flowing through the second switch and reversal of current direction;
switching off the second switch, wherein switching off the second switch causes a first capacitance associated with the first switch to discharge and causes a second capacitance associated with the second switch to charge; and
switching on the first switch after the second switch has been switched off.

14. The method of claim 13, wherein the auxiliary circuit comprises a third switch, a second inductor, and a first diode.

15. The method of claim 14, wherein the third switch, second inductor, and first diode are coupled in series to each other.

16. The method of claim 14, wherein each of the first switch, second switch, and third switch comprises at least one of a transistor and a diode.

17. The method of claim 14, wherein the first switch, second switch, first inductor, and auxiliary circuit are part of a power converter.

18. The method of claim 17, wherein the power converter is a DC-to-DC power converter comprising one of a synchronous buck converter, boost converter, buck-boost converter, Cuk converter, single-ended primary inductor converter (SEPIC), and multiphase converter.

19. The method of claim 17, wherein the third switch is configured to be bidirectional to support bidirectional currents and bipolar voltages.

20. The method of claim 19, wherein the power converter is one of a DC-to-AC power converter, AC-to-DC power converter, and DC-to-DC bidirectional power flow converter.

21. The method of claim 13, wherein the first capacitance associated with the first switch discharges and the second capacitance associated with the second switch charges until a voltage across the first switch is approximately zero, and wherein the first switch is switched on after the voltage across the first switch is approximately zero.

22. The method of claim 13, further comprising switching off the auxiliary circuit after the first switch has been switched on and the current through the auxiliary circuit is approximately zero.

23. The method of claim 22, further comprising controlling switch timing of the third switch adaptively based on operating conditions of a power converter that includes the auxiliary circuit, wherein the operating conditions comprise at least switch voltages and currents.

24. The method of claim 13, wherein a voltage across the second switch is approximately zero immediately prior to switching on the second switch.

25. The method of claim 13, wherein a first terminal of the first switch, a first terminal of the second switch, and a first terminal of the first inductor are coupled to a first node.

26. The method of claim 13, wherein the auxiliary circuit further comprises a resistor and a capacitor to prevent current pulses from an output load or input power source.

27. The method of claim 13, wherein the auxiliary circuit further comprises a second diode.
